(19) United States
(12) Patent Application Publication
(10) Pub. No.: US 2008/0073606 A1
(43) Pub. Date: Mar. 27, 2008

(54) VALVE ASSEMBLY WITH MAGNETICALLY COUPLED ACTUATOR

(76) Inventor: Vito M. Liantonio, Glen Cove, NY (US)

Correspondence Address: Ronald J. Baron, Esq.;HOFFMANN & BARON, LLP, 6900 Jericho Trunpike, Syosset, NY, 11791, US

(21) Appl. No.: 11/535,109

(22) Filed: Sep. 26, 2006

(51) Int. Cl. F16K 31/08

(52) U.S. Cl. 251/65

(57) ABSTRACT

A valve assembly having a housing including a first and second port. A closure element is disposed within the housing and is selectively moveable between an open position wherein the first port is in fluid communication with the second port and a closed position wherein fluid communication between the first and second ports is blocked and/or controlled. A first magnet assembly is coupled to the closure element for actuating the closure element between the open and closed positions whereby the fluid communication is blocked and/or controlled. A second magnet assembly is magnetically coupled to the first magnet assembly for imparting movement to the first to provide fluid communication blocking and/or controlling. The drive mechanism is adapted to actuate the second magnetic assembly and is alternatively operable through a first and/or a second drive input. The first drive input is unable to drive the second drive input.

### BACKGROUND OF THE INVENTION

The invention relates to a sealed fluid valve utilizing a magnetically coupled piloted valve providing a hermetically sealed control valve with improved flow control elements.

Conventional valves have an inlet port and outlet port which are separated by a valve closure element which controls the flow of fluid from the inlet to the outlet. The valve typically has a mechanical movement which moves the closure element from a closed position to an open position. In some prior designs a valve housing is provided having an opening to allow a screw type mechanism to move the closure element from the open to the closed positions and vice versa. Screw mechanisms in these types of valve arrangements would pass through the outer housing of the valve and include a hand wheel or other device to turn the screw mechanism to move the valve between open and closed positions. Such screw mechanisms also include a packing material to provide a dynamic seal between the screw shaft, which is connected directly to the closure element, and the outer housing to prevent leakage of fluid from the valve. However, a problem with this prior design is that it requires constant maintenance of the packing to prevent fluid leakage. Such valves are frequently unacceptable due to fluid leakage to the environment, requiring the use of hermetically sealed designs.

An alternative contemporary design uses a solenoid valve to control the fluid flow. The solenoid valve involves the use of a magnetic movable core which is mechanically linked to the valve closure element. The movable core is typically housed in a cylinder or other housing adjacent to the closure element. An electromagnetic field is produced by an electric coil to control the movement of the movable core to move the closure element between open and close positions. Typically, the magnetic coil is energized to move the core to in turn move the closure element to an open position to allow fluid to flow from either the inlet to the outlet or from the outlet to the inlet port. However, the problem with the solenoid valves currently in use is that if a large valve is needed for a particular application, the amount of energy required to move the movable core and closure element is very great. In addition, once the valve is opened, the magnetic coil must be maintained in an energized state to hold the movable core in an open position. If the movable core is extremely heavy or large, the magnetic coil must be fully energized from the initial stages to the final open stage. This type of solenoid valve consumes a large amount of energy and is not efficient.

Thus, it is desirable to provide a valve assembly which overcomes the shortcomings found in the art of valves as set forth above while also providing improved structural and operating features.

### SUMMARY OF THE INVENTION

One aspect of the present invention includes a valve assembly having a housing, a first magnet assembly, a second magnet assembly and a drive mechanism. The housing includes a first port and a second port. The closure element is disposed within the housing and is selectively moveable between an open position wherein the first port is in fluid communication with the second port and a closed position wherein fluid communication between the first and second ports is at least one of blocked and controlled. The first magnet assembly is coupled to the closure element, for actuating the closure element between the open position and the closed position whereby the fluid communication is at least one of blocked and controlled. The second magnet assembly is magnetically coupled to the first magnet assembly for imparting movement to the first magnetic assembly to provide at least one of the fluid communication blocking and controlling. The drive mechanism is adapted to actuate the second magnetic assembly. Also, the drive mechanism is alternatively operable through at least one of a first drive input and a second drive input, wherein the first drive input is unable to drive the second drive input.

Additionally, the movement imparted to the first magnet assembly could be either rotational or axial movement, depending on the design. Further, the first and second magnet assemblies could be separated by a barrier, preventing fluid communication past the first and/or second magnet assemblies. Further still, the drive mechanism could include a gear assembly continuously engaged from said second magnet assembly to the first and/or second drive inputs. Also, the closure element could include a pilot valve.

Additionally, the valve closure element could include a stem and a first valve disc. The stem could be coupled to the first magnet assembly and the first valve disc. Also, the first valve disc could be contained within the housing and adapted to fully block fluid communication between said first and second ports. Further, the stem could be threadedly engaged to the first magnet assembly. Further still, the valve closure element could include a second valve disc and a disc fluid passage through the first valve disc in fluid communication with said first and second ports. The second valve disc could be contained within the first valve disc. Also, the second valve disc could be moveable between a first position blocking the one disc fluid passage and a second position allowing fluid communication through the disc fluid passage.

Another aspect of the present invention involves a valve assembly including a housing having a first port and a second port. A valve closure element is disposed within the housing, and the closure element includes a stem and first disc. The first disc is coupled to the stem and selectively moveable between a first position and a second position. The first position places the first port in fluid communication with the second port. The second position blocks and/or restricts fluid communication between the first and second ports. A first magnet assembly is threadedly engaged to the stem for actuating the head cylinder between the first and second positions. A second magnet assembly magnetically is coupled to the first magnet assembly for actuating the first magnetic assembly thereby providing the actuation of the head cylinder. Also, a drive mechanism is provided for actuating the second magnetic assembly thereby actuating the first magnetic assembly.

It is desirable to provide a valve that does not require packing and eliminates maintenance and other troubles associated with leakage of external dynamic seals in a valve assembly. It is further desirable to provide a valve having a completely hermetically sealed outer housing that does not have any through openings to reduce or prevent leakage to the outer environment of fluid flowing through the valve. It is further desirable to provide a valve which uses a pilot disc which reduces the actuating forces required to open, close and/or adjust the valve opening. And it is desirable to provide a valve which provides exquisite command of the valve closure element so that fluid flow is more precisely controlled thereby reducing and/or preventing damage to the valve seat upon closure.

These and other objective, features, and advantages of this invention will become apparent from the following detailed description of illustrative embodiments thereof, which is to be read in connection with the accompanying drawings.

### BRIEF DESCRIPTION OF THE DRAWINGS

FIG. 1 is a cross-sectional view of a valve assembly in accordance with an embodiment of the present invention.

FIG. 2 is an enlarged cross-sectional view of portions of the valve housing, disc collar and inner disc assemblies of FIG. 1.

FIG. 3 is an enlarged cross-sectional view of the magnet housing assembly of FIG. 1.

FIG. 4a is an enlarged perspective view of the magnet assemblies of FIG. 1.

FIG. 4b is a front view of the magnet assemblies of FIG. 4a.

FIG. 4c is a cross-sectional view of the magnet assemblies of FIG. 4b at A-A.

FIG. 5 is a cross-sectional view of a valve assembly in accordance with an alternative embodiment of the present invention.

FIG. 6a is an enlarged perspective view of the magnet assemblies of FIG. 5.

FIG. 6b is a front view of the magnet assemblies of FIG. 6a.

FIG. 6c is a cross-sectional view of the magnet assemblies of FIG. 6b A-A.

FIG. 7 is an enlarged cross-sectional view of the gear assembly of FIG. 5.

FIG. 8 is an alternative enlarged cross-sectional view of a gear box with an extension housing and encoder assembly.

### DETAILED DESCRIPTION OF THE INVENTION

This invention pertains to a valve assembly that offers exquisite control of the valve disc position, selectively by either manual or motor drive input, while providing a hermetically sealed design.

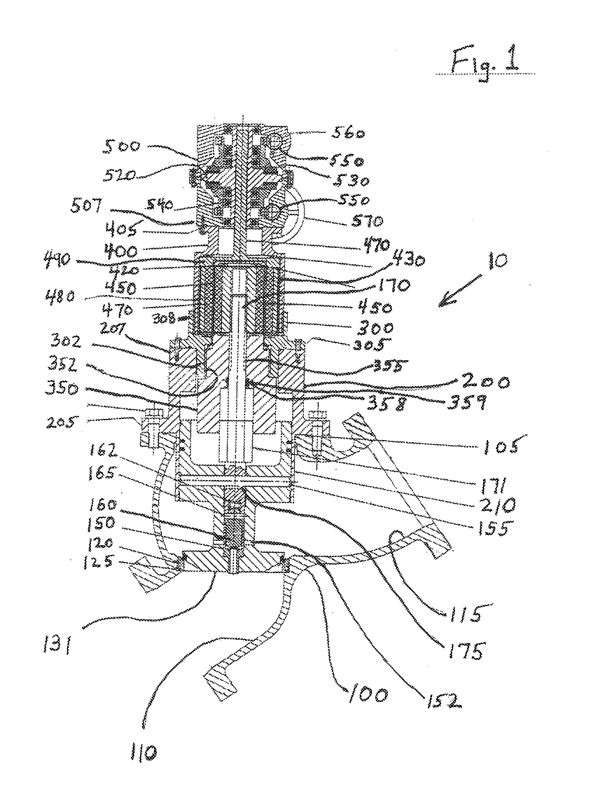

With reference to the drawings, FIG. 1 shows a piloted globe valve assembly 10. The outer elements of the valve assembly 10 preferably include a valve housing 100, a valve disc collar 200, a bonnet 300, a magnet housing 400 and a gear box 500. It is desirable that the outer elements 100, 200, 300, 400, 500 be secured in such a way as to hermetically seal the overall assembly 10 and prevent either external leakage or internal contamination. As shown, some of the outer elements are provided with coupling flanges 105, 205, 305, 405 or surfaces 207, 507 for securing and sealing adjacent outer elements, using conventional fasteners and seals. Also, some of the outer elements are joined through mating threads 303, 403.

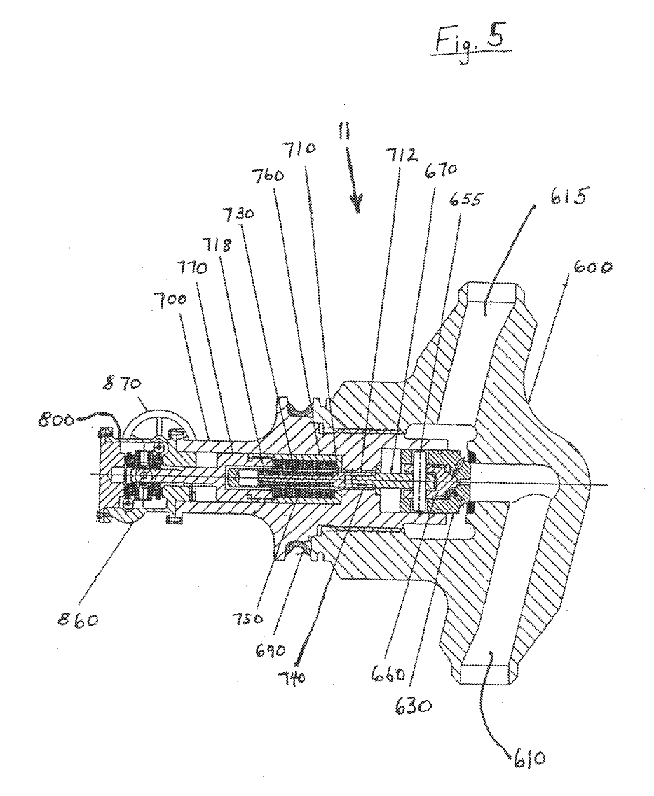

It should be understood that some or all of the outer elements 100, 200, 300, 400, 500 could be integrally formed or formed into a single continuous element. For example, the embodiment shown in FIG. 5 illustrates a valve assembly 11 formed with fewer outer elements. Alternatively, the outer elements in any embodiment could be formed by more parts than that shown. Also, additional or redundant sealing elements can be employed, such as a bellows or flexible membrane. For example, the canopy ring 330 shown in FIG. 5 ensures a hermetic seal between valve housing 101 and magnet housing 401.

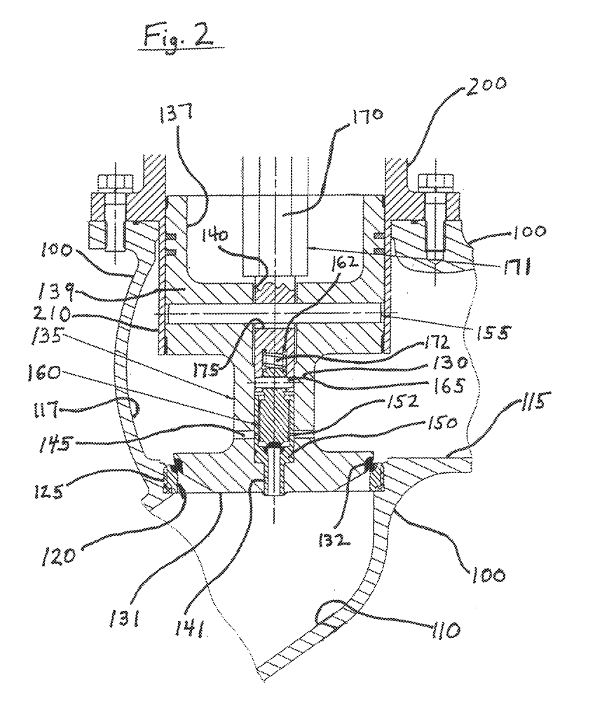

Referring to FIGS. 1 and 2, the valve assembly 10 preferably includes a valve housing 100 that has a first port 110 and second port 115. The housing 100 contains a main closure element or disc 130, which is shown in more detail in FIG. 2. The main disc 130 controls the flow of fluid communicating between the first 110 and second 115 ports. Preferably, the main disc 130 is moveable between a closed position, shown in FIG. 1 and at least one open position (not shown). The open position can vary to regulate or control the flow of fluid. In the closed position, a portion 132 of the main disc head 131 engages a disc seat 120 in order to block fluid flow. The disc seat 120 rests in a seat ring 125 positioned in the interior wall of housing 100. Additional elements can be provided at the contact points between the main disc 150 and the disc seat 120 in order to control or prevent leakage across the seal, as is known to those of ordinary skill in the art. Preferably, the main disc 130 is made of a material that is harder than or equal in hardness to the disc seat 120. In low pressure/temperature applications the materials can be base metals, such as bronze or grade 316 stainless steel (316SS), or softer non-metallic materials, such as Teflon, polyimide or rubber. However, the design is not limited to any specific materials, but rather certain materials properties are preferred based on application parameters, such as what types of fluids, pressures and temperatures are involved and how tight a seal is desired.

Main Disc 130 preferably includes a base 139 and a stem 135. The diameter of the main disc stem 135, while preferably narrower than either the main disc head 131 or the main disc 139, could be designed with a smaller or larger diameter than that shown. By reducing the diameter of a portion of the main disc 130, such as a central stem 135, the weight and mass of the main disc 130 is also reduced, making it easier to move. However, it is understood that the main disc 130 is not required to have narrower stem 135. Additionally, main disc 130 also preferably includes a cavity 137 in at least an upper portion of disc base 139. It should be understood that the terms “upper” and/or “lower” used herein refer to the orientation(s) shown in referenced drawings. Further, the main disc 130 has an inner bore 140 that traverses the axial length of the main disc 130 from the lower surface of the main disc head 131 to the cavity 137. The inner bore 140 also preferably includes a narrower portion or head nozzle 141 inside at least a lower portion of the main disc head 131.

Contained within the main disc bore 140 and head nozzle 141 preferably is sleeve 150. The sleeve 150 is a hollow element that contains and guides a secondary closure element or pilot disc 160, and extends through nozzle 141. The use of a piloted disc design reduces the required actuator forces necessary to move main disc 130 from a closed position to open the valve 10. Sleeve 150 provides an inner lining to the lower portion of bore 140 and the nozzle 141. Also, a portion of sleeve 150 engages the pilot disc 160 in much the same way as the disc seat 120 engages the main disc head 131. Thus, when pilot disc 160 is in a lowermost position, it should provide a sealed engagement with sleeve 150. The sleeve 150 should be made of a material that is appropriate to the environment of the overall valve, and should be particularly suited to guide the pilot disc without being galled. Examples of preferred materials are 316SS, Nitronic 60® (AK Steel Corp., Middletown, Ohio), bronze or even polymer materials, such as Teflon® (Du Pont, Wilmington, Del.). However, other considerations such as cost, performance and/or the interaction or relationship with other parts in the assembly could also be considered when selecting materials. Additionally, sleeve 150 should have one or more openings 152, which align and are in fluid communication with one or more fluid passages 145 in the main disc stem 135. The fluid passages 145 are in fluid communication with valve chamber 117, which is preferably in open fluid communication with outlet port 115.

Pilot disc 160 is adapted to move axially within sleeve 150 between a first position (shown in FIGS. 1 and 2) wherein fluid flow is interrupted between inlet port 110 and fluid passages 145, and a second position (not shown) wherein fluid flow is established between inlet port 110 and fluid passages 145. Pilot disc 160 is preferably actuated via a pilot disc stem 170 that is in turn axially actuated by a drive mechanism, as discussed in more detail below. The initial axial displacement of stem 170 causes pilot disc 160 to move from its first position toward a second position above opening(s) 152, thus establishing a fluid connection between head nozzle 141 and fluid passage(s) 145. Additional axial displacement of stem 170 preferably results in the movement of main disc 130 from the closed position to an open position providing direct fluid communication between inlet port 110 and outlet port 115.

A pilot disc pin 165 preferably couples pilot disc 160 to stem 170. Preferably, a biasing element 162 exerts axial pressure on pilot disc 130 relative to the stem 170 in order to maintain engagement between those elements 130, 170 and the pilot disc pin 165 that holds them together. FIGS. 1 and 2, show biasing element 162 in the form of a coil spring mounted in a recess 172 in the lowermost portion of stem 170. The spring 162 also applies pressure to a top portion of the pilot disc 160. It should be understood in the art, that other more or less elaborate means of biasing could be used in place of the configuration shown. Also, alternatively no biasing element need be provided between the pilot disc 160 and the stem 170.

In contrast to the configuration of the pilot disc pin 165, main disc pin 155 preferably couples main disc 130 to stem 170 without a biasing element applying pressure there between. In fact, stem 170 preferably includes a pin passage 175 that has a larger diameter than the diameter of main disc pin 155. Thus, upward axial movement of stem 170 from the position shown in FIG. 2 will not immediately engage stem 170 with main disc pin 155. This configuration enables pilot disc 160 to actuate prior to main disc 130. In this way, upon positive contact between the lower side of stem passage 175 with main disc pin 155, main disc 130 is moved in unison with stem 170, thus causing main disc 170 to move to an open position. Once moved to an open position, main disc 130 can be once again moved to a closed position after stem 170 moves downward causing main disc pin 155 to make positive contact with the upper side of stem passage 175.

The main disc base 139 acts like a piston guided within the lower portion 210 of collar 200. The collar 200 encloses portions of the stem 170 as well as the stem guide 350. As mentioned above, it should be understood that collar 200 could alternatively be integrally formed with either the valve housing 100 or the bonnet 300.

As further shown in FIG. 1, bonnet 300 is mounted and secured to the top of collar 200. The bonnet 300 is also preferably provided with stem guide mating threads 302 on its lower end that mate with outer threads 352 on the stem guide 350. Also, the bonnet 300 is provided with magnet housing mating threads 308, which are preferably adapted to mate with outer threads 408 on the magnet housing 400. It should be understood that bonnet 300 and stem guide 350 could be integrally formed. Providing separate bonnet 300 and stem guide 350 elements allows the use of different materials, such as materials better suited as a guide surface versus corrosion resistant materials. As with virtually all materials of the present valve assembly, the intended application (i.e., working environment and fluid being handled) can greatly influence the choice of materials.

The stem guide 350 is preferably an annular member that includes an inner stem passage 355. The stem passage 355 allows the pilot stem 170 to move up and down (back and forth) within, when the valve is being moved between the closed and open positions. It is desirable that at least a portion of the stem passage 355 have a non-circular cross-section (shown as the lower portion of stem passage 355) that matches the slightly smaller non-circular cross-section of portion 171 of the pilot stem 170. As discussed further below, the non-circular mating configuration between the pilot stem 170 and the stem passage 355 should allow axial movement, but prevent the pilot stem from rotating relative to the assembly. FIGS. 1 and 2 show a hexagonal lower portion of the stem passage 355 that guides the central stem position 171 that comprises a similar hexagonal cross-section. Additionally, the stem passage 355 is preferably provided with a stem seal 358 to prevent communication of fluids through the passage 355. It should be understood that additional sealing elements can be provided throughout the assembly to ensure or improve the hermetic sealing of the valve assembly 10. Although stem seal 358 is a dynamic seal, it is desirable to avoid dynamic seals especially that penetrate the outer housing elements, to further ensure a hermetic seal. It will be recognized that such a design eliminates or greatly minimizes any possibility of leakage, and also greatly reduces the amount of maintenance normally required in such environments. Further, debris magnets 359 are also preferably included within the stem passage 355 to trap the migration of dust or the like within the assembly. Once assembled as shown in FIG. 1, the upper end of the stem guide 350 acts as a retainer for the lower side of the inner portions of the magnet assembly 410.

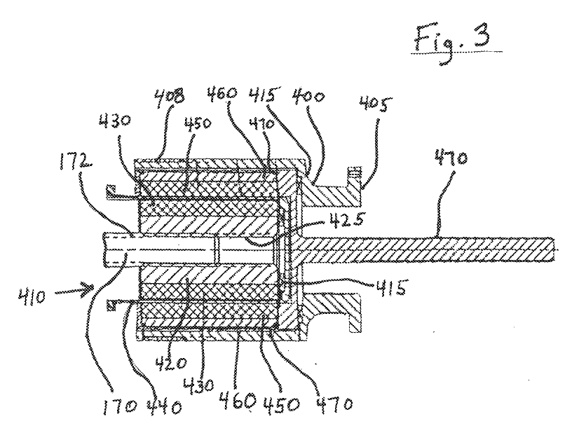

The magnet housing 400 preferably contains the primary magnetic coupling components of the assembly. The magnet assembly 410 that is contained within the magnet housing 400, shown in FIG. 3, includes an inner set of plunger magnets 430 and an outer set of actuator magnets 450. These concentrically configured sets of magnets 430, 450 translate the actuating forces from the actuator stem 470 to the pilot stem 170. The sets of magnets 430, 450 are preferably separated by a tube or sleeve 440 that further ensures a hermit seal on the overall assembly.

Located adjacent to bonnet 300, the magnet housing 400 preferably encloses the threaded end 178 of pilot stem 170 that is opposite the end secured to the pilot disc 160. As shown in FIG. 3, the pilot stem threading 178 is slidingly engaged with the inner guide threads 425 of the pilot stem coupling 420. In this way, since the pilot stem 170 is prevented from rotating by the non-circular portions of the stem passage 355, rotation of the pilot stem coupling 420 translates into axial displacement of the pilot stem 170.

The pilot stem coupling 420 forms the innermost part of the magnet assembly 410 and supports the inner set of plunger magnets 430, which are secured thereto. The plunger magnets 430 could be secured to the pilot stem coupling 420 in various known ways, such as the use of bonding agents, mating keys/slots or other fastening techniques. Similarly, the actuator magnet retainer 460 forms the outermost part of the magnet assembly 410 and supports the outer set of actuator magnets 450, which are secured thereto. FIG. 3 more clearly shows thrust bearings 415 used on the actuator side of the assembly to compensate for axial forces on both the inner 430 and outer 450 sets of magnets. As shown in FIG. 1, such thrust bearings are also preferably used on the opposite side of the magnet assembly 410.

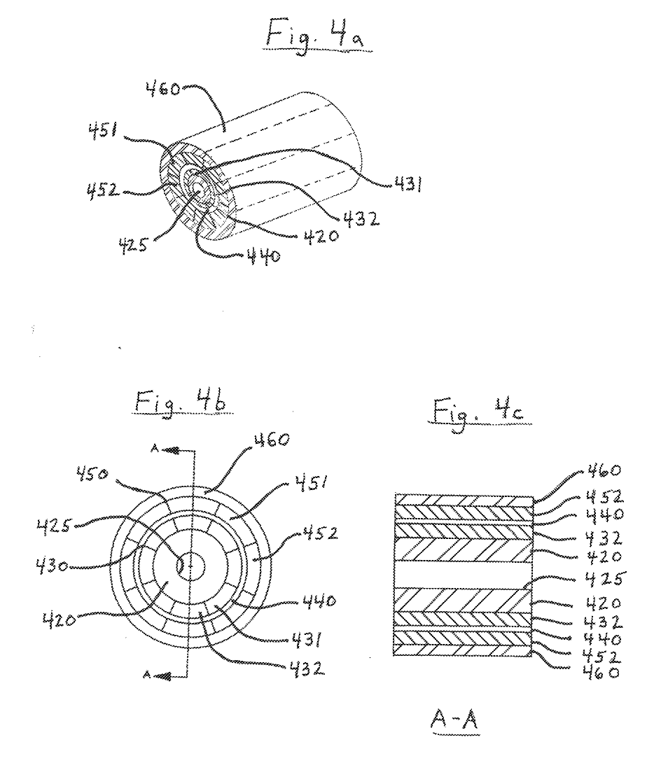

As shown in FIGS. 4a, 4b and 4c, each of the sets of magnets 430, 450 comprise bar-shaped permanent magnets 431, 451 sandwiched between permeable iron bars 432, 452, configured in an annular arrangement. Alignment of the magnetic flux fields of the inner 430 and outer 450 cells creates a strong attractive force that resists relative rotation between those sets of magnets 430, 450. Thus, once the cells 430, 450 are aligned by the magnetic forces, they define a stable “null” position. Relative rotational movement between magnets 430, 450 results in an opposing force biasing the magnets to return to a null position. Thus, rotational movement of the outer cells 450 encourages similar rotational movement of the inner cells 430. Also, the opposing force increases as the cells 430, 450 move from the null position, until they reach alignment with an adjacent cell. However, the magnet assembly 410 should be designed with sufficiently strong magnetic forces to avoid rotational displacement that reaches or goes beyond direct alignment with the adjacent cells. In fact, in a preferred embodiment, the magnet assembly 410 is designed to resist 10 times the maximum loads predicted or required by guidelines or specifications, before slipping.

As shown in FIG. 1, the gear box 500 transfers the actuating forces to the actuator stem 470. The gear box is preferably provided with both a motor input drive 560 and a manual input drive 570. The input drives 560, 570 independently turn a worm gear 550, which in turn rotates a combination rotary gear 540. The combination rotary gear preferably includes a portion that couples to the worm gears 550 and a portion that couples to a bevel gear 530. It is the bevel gear 530 that rotates around the axis of the actuator stem 470. Also, bevel gear 530 transfers rotational movement to bevel gear carrier 520, which is in turn secured to the actuator stem 470. Preferably, the combination rotary gear 540 can not back-drive the worm gears 550. Thus, once the input drives 560, 570 stop, the discs 130, 160 are retained in a fixed position. In this way, failure of the motor or manual input stops the valve opening, results in a “fail-as-is” design. Also, neither of the input drives 560, 570 can drive the other. It should be understood that various drive input mechanisms can be used in combination with the gear box 500 of the present invention. For example, electric, air and/or hydraulic motors could be used.

FIG. 5 shows an alternative embodiment valve assembly 11 that uses a magnetic coupling that transfers axis forces, rather than the rotational version discussed above. Also, the embodiment shown in FIG. 5, integrally forms some of the outer elements, thus reducing the number of parts that form the outer housing for the overall assembly. The valve housing 600 combines elements of the previously discussed valve housing 100 and disc collar 200. Also, the magnet housing 700 combines elements of the previously discussed disc collar 200, bonnet 300, stem guide 350 and magnet housing 400. Further, the valve assembly 11 uses a flexible bellows or canopy ring 690 that seals together the outer elements 600, 700. As mentioned above, it should be understood that alternative seals and couplings could be employed as are known in the art.

The valve housing 600 includes inlet 610 and outlet 615 ports. The main disc 630 has a more continuous cylindrical design than that used for disc 130. Also, main disc 630 and pilot disc 660 share a common disc pin 655. A larger pin passage is preferably provided in main disc 630 than that provided in pilot disc 660. In this way, the pilot disc 660 will respond to the axial movements of disc stem 670 before main disc 630 will respond.

Valve assembly 11 actuates axial movement of the disc stem 670 through plunger 710, in contrast to the rotational movement of the previous embodiment. The rotational movement design can produce higher actuating forces for comparably sized magnet assemblies. However, the axial movement design is well suited for low-pressure on-off valves. In valve assembly 11, plunger 710 is secured at its base 712 to the disc stem 670, while secured at its other end to plunger cap 718. The disc stem 670 is preferably threadedly engaged with plunger base 712. The stepped profile of the plunger 710 together with the plunger cap 718 axially secures the plunger magnets 730 to the plunger 710. As in the previously discussed embodiment, the plunger magnets 730 and the actuator magnets 750 are separated by a tube or bonnet sleeve 740. Also, the outer magnet cells 750 are held together by a retainer 760. The actuator magnet retainer is secured to and transfers axial movement from actuator stem 770 to the actuator magnets 750 and thus the overall magnet assembly.

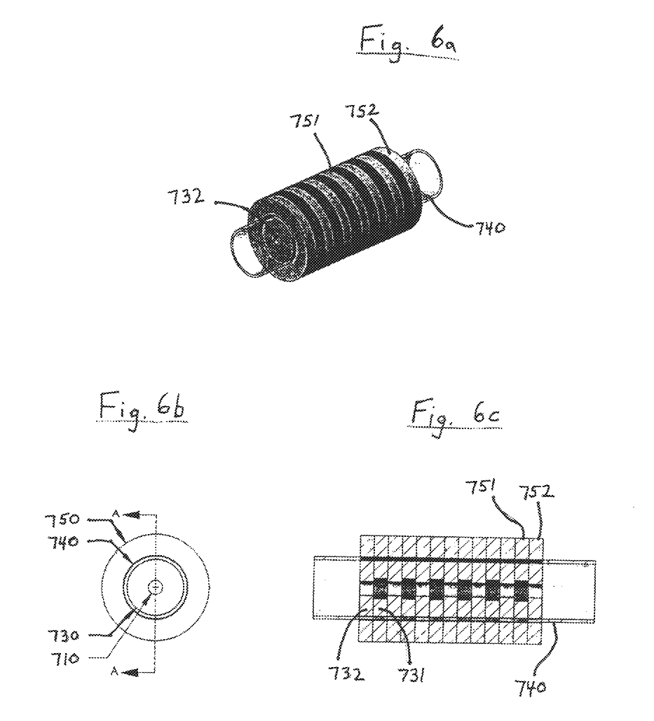

FIGS. 6a, 6b and 6c show portions of the magnetic assembly of FIG. 5. Both the plunger magnets 730 and the actuator magnets 750 comprise annular permanent magnets 731, 751 sandwiched between annular permeable iron magnets 732, 752 configured in an axial arrangement. Alignment of the magnetic flux fields of the inner 730 and outer 750 cells creates a strong attractive force that resists relative axial displacement between those sets of magnets 730, 750. Thus, similar to the previous embodiment, once the cells 730, 750 are aligned by the magnetic forces, they define a stable “null” position. Relative axial movement between magnets 730, 750 results in an opposing force biasing the magnets to return to a null position. Thus, axial movement of the outer cells 750 encourages similar axial movement of the inner cells 730.

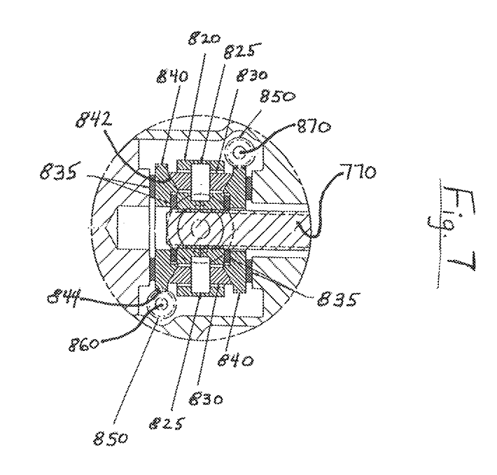

FIG. 7 shows additional details of gear box 800, which axially actuates the stem 770. Similar to gear box 500, gear box 800 is preferably provided with a motor input drive 860, a manual input drive 870 and internal bearings 835. The input drives 860, 870 independently turn a worm gear 850, which in turn rotates a combination rotary gear 840. The combination rotary gear 840 preferably includes a worm gear portion 844 that couples to the worm gears 850 and a beveled portion 842 that couples to a bevel gear 830. Bevel gears 830 are mounted on gear pins 825 and carrier 820. Rotation of the combination rotary gear 840 preferably not only causes rotation of the beveled gears 830 but also causes them to act as planetary gears that orbit the axis of the stem 770, along with the pins 825 and carrier 820. The carrier 820 is threadedly engaged with stem 770, such that rotation of carrier 820 axially displaces the actuator stem 770. The gear box 800 has a similar “fail-as-is” design to that of gear box 500.

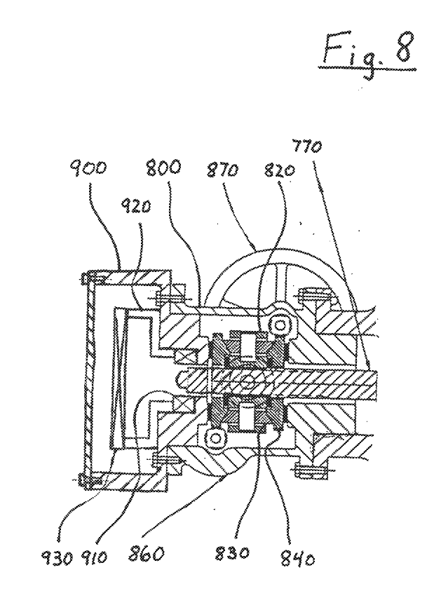

As a further alternative embodiment, position indicators or position feedback systems, as shown in FIG. 8, can be employed for tracking the position of one or more stems 170, 470, 670, 770. A shaft position encoder (SPE) 910 is a device that transmits an analog voltage that is proportional to the stem's position. The SPE 910 can be a commercial-off-the-shelf unit or one customized to suit a particular valve application. Preferably, optical encoders could be used to accurately measure shaft position. Also, optical encoders avoid internal parts that will wear over time. Thus, as shown in FIG. 8 an extension housing 900 can be secured to the gear box 800, in order to contain and protect the SPE's 910, as well as programmable control systems 930 and other supporting structure 920. An SPE 910 located at the top of the actuator could also be used in conjunction with another SPE (not shown) located on the other side of the gear assembly, toward the main disc 130. Such SPE's 910 can be used to track axial or rotational displacement, based on the valve design employed and which portion of the assembly is being tracked.

One benefit to using position encoders it that operation of the valve assembly 10, 11 can be preprogrammed and closely controlled and/or maintained by computer. Additionally, a computer can easily translate the analog signal transmitted by an encoder into a user friendly display, which provides a precise position indicator. Also, the signal information can be stored or analyzed for diagnostic purposes. Further, the computer could also be used to control the motorized input drive 560, 860, which would provide the ability to pulse the main 130 or pilot 160 discs to seat and/or precisely stop, as desired. Such automation can prevent damage to the valve and particularly the main 130 and/or pilot 160 discs. Also, by further monitoring of the motorized input device 560, 860 un-safe torque or current levels can be further indicated through either a visual or audio alarm.

While various embodiments of the present invention are specifically illustrated and/or described herein, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A valve assembly comprising:
a housing having a first port and a second port;
a valve closure element disposed within said housing, said closure element selectively moveable between an open position wherein said first port is in fluid communication with said second port, and a closed position wherein fluid communication between said first and second ports is at least one of blocked and controlled;
a first magnet assembly coupled to said closure element, for actuating said closure element between said open position and said closed position whereby said fluid communication is at least one of blocked and controlled;
a second magnet assembly magnetically coupled to said first magnet assembly for imparting movement to said first magnetic assembly to provide at least one of said fluid communication blocking and controlling; and
a drive mechanism adapted to actuate said second magnetic assembly, said drive mechanism alternatively operable through at least one of a first drive input and a second drive input, wherein said first drive input is unable to drive said second drive input.

2. The apparatus of claim 1, wherein said movement imparted to said first magnet assembly is rotational movement.

3. The apparatus of claim 1, wherein said movement imparted to said first magnetic assembly is axial movement.

4. The apparatus of claim 1, wherein said first and second magnet assemblies are separated by a barrier preventing fluid communication past at least one of said first and second magnet assemblies.

5. The apparatus of claim 1, wherein said drive mechanism includes a gear assembly continuously engaged from said second magnetic assembly to at least one of said first and second drive inputs.

6. The apparatus of claim 5, wherein both said first and second drive inputs are continuously engaged with said gear assembly.

7. The apparatus of claim 1, wherein at least one of said first and second drive inputs is a motor driven assembly.

8. The apparatus of claim 1, wherein said valve closure element includes at least one pilot valve.

9. The apparatus of claim 1, wherein said valve closure element includes a stem and a first valve disc, said stem coupled to said first magnet assembly and said first valve disc, said first valve disc contained within said housing and adapted to fully block fluid communication between said first and second ports.

10. The assembly of claim 9, wherein said stem is threadedly engaged to said first magnet assembly.

11. The assembly of claim 9, wherein said valve closure element further includes a second valve disc and at least one disc fluid passage through said first valve disc in fluid communication with said first and second ports, said second valve disc contained within said first valve disc, said second valve disc moveable between a first position blocking said at least one disc fluid passage and a second position allowing fluid communication through said at least disc fluid passage.

12. The assembly of claim 1, further comprising:
a position feedback system coupled to said housing for tracking the position of said valve closure element.

13. An valve assembly comprising:
a housing having a first port and a second port;
a valve closure element disposed within said housing, said closure element including a stem and a first disc, said first disc coupled to said stem and selectively moveable between a first position wherein said first port is in fluid communication with said second port, and a second position wherein fluid communication between said first and second ports is at least one of blocked and restricted relative to said first position;
a first magnet assembly threadedly engaged to said stem, for actuating said first disc between said first and second positions;
a second magnet assembly magnetically coupled to said first magnet assembly for actuating said first magnetic assembly thereby providing said actuation of said first disc; and
a drive mechanism for actuating said second magnetic assembly thereby providing said actuation of said first magnetic assembly.

14. A valve assembly according to claim 13, wherein said first magnet assembly actuation includes rotational movement of said first magnet assembly.

15. A valve assembly according to claim 13, wherein said first magnet assembly actuation includes axial movement of said first magnet assembly.

16. A valve assembly according to claim 13, wherein said drive mechanism includes a gear assembly continuously engaged from said second magnetic assembly to at least one drive input.

17. A valve assembly according to claim 13, wherein said at least one drive input includes a first and second drive input.

18. The assembly of 13, wherein said stem is threadedly engaged to said first magnet assembly.

19. The assembly of claim 13, wherein said valve closure element further includes a second valve disc and at least one disc fluid passage through said first valve disc in fluid communication with said first and second ports, said second valve disc contained within said first valve disc, said second valve disc moveable between a first position blocking said at least one disc fluid passage and a second position allowing fluid communication through said at least disc fluid passage.

20. The assembly of claim 13, further comprising:
a position feedback system coupled to said housing for tracking the position of said valve closure element.
